(19) United States
(12) Patent Application Publication
(10) Pub. No.: US 2025/0342057 A1
(43) Pub. Date: Nov. 6, 2025

(54) Efficient Cloud Computing Resource Usage

(71) Applicant: ServiceNow, Inc., Santa Clara, CA (US)

(72) Inventor: Sagar Gupta, Bangalore (IN)

(21) Appl. No.: 18/652,042

(22) Filed: May 1, 2024

(51) Int. Cl. G06F 9/50

(52) U.S. Cl. CPC G06F 9/5027

(57) ABSTRACT

Example implementations may include: receiving, from a computing system, usage data including entries specifying usage of computing resources of the computing system; storing, as structured data, records that include representations of the entries; after storing the records, determining, based on an efficiency criterion and for a time range of the records, inefficiencies related to the usage of the computing resources; and providing a notification indicating the inefficiencies and a subset of the computing resources that are producing the inefficiencies.

### BACKGROUND

Cloud computing platforms offer a wide range of remote services including computing power, storage options, networking capabilities, machine learning, and other utilities that allow users to execute applications and manage data. Advantageously, these platforms typically take the form of server arrays hosted in a remote data center and are accessible by way of a wide-area network, replacing local servers or personal computers. However, it is difficult for any entity-especially a large entity that heavily uses a cloud computing platform-to keep track of the cloud-based computing resources that it is using. As a consequence, these computing resources can be over-provisioned, under-provisioned, or inefficiently allocated, thus wasting computing power, storage, network capacity, energy, and so on.

### SUMMARY

Various implementations disclosed herein include systems and methods for efficiently storing usage data relating to computing resources of a cloud-based platform. The storage systems may be based on blockchain (and thus resistant to tampering or accidental change) or a time-series database (and thus able to facilitate random access rapid retrieval of specific records), as just two possibilities. Once stored, the system can mine records to determine inefficiencies in the allocation and/or use of the computing resources (e.g., allocating too much or too little of computing power, storage, or capacity in the cloud-based platform). When such inefficiencies are detected, the system can provide a notification to a user or organization. In some cases, the system may automatically reallocate computing resources to reduce the inefficiencies. Further, the system may estimate the carbon footprint of recent usage of the computing resources and propose alternative arrangements employing lower-power computing and storage technologies.

In this fashion, the systems and methods disclosed herein mitigate wastage of computing resources. Further, the systems can reallocate unused or under-utilized processing power and storage to more productive uses. Moreover, the systems may identify and replace older computing resources that consume more power per compute cycle or megabyte of storage with more efficient models. These savings are especially important as cloud platform providers are seeking to expand their data centers dramatically over coming years to house hardware platforms that can train and execute the next generation of artificial intelligence models.

Accordingly, a first example embodiment may involve receiving, from a computing system, usage data including entries specifying usage of computing resources of the computing system; storing, as structured data, records that include representations of the entries; after storing the records, determining, based on an efficiency criterion and for a time range of the records, inefficiencies related to the usage of the computing resources; and providing a notification indicating the inefficiencies and a subset of the computing resources that are producing the inefficiencies.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a cloud-based platform usage report, in accordance with example embodiments.

FIG. 7 depicts blocks within a blockchain, in accordance with example embodiments.

FIG. 8 depicts nodes of a blockchain, in accordance with example embodiments.

FIG. 9 depicts an example architecture configured to analyze computing resource usage, in accordance with example embodiments.

FIG. 10 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. EXAMPLE TECHNICAL IMPROVEMENTS

These embodiments provide a technical solution to a technical problem. One technical problem being solved is overuse and underuse of computing resources on cloud-based platforms. In practice, this is problematic because currently it is practically infeasible to accurately determine these inefficiencies for non-trivial cloud-based deployments.

In the prior art, usage reports relating to utilization of the computing resources were made available by cloud-based providers. However, these reports were extensive, including possibly tens of thousands or hundreds of thousands of individual entries and thus were not conducive to traditional analysis. Accordingly, prior techniques relied on subjective decisions and experiences of administrators, which lead to wildly varying outcomes from instance to instance. Thus, prior art techniques did little if anything to determine or address the actual inefficient use of computing resources in cloud-based platforms.

The embodiments herein overcome these limitations by placing the entries into records of structured data (e.g., blockchains, time series databases, or other storage systems). In this manner, inefficient allocations of computing resources can be identified in a more accurate and robust fashion. This results in several advantages. First, various patterns of inefficient computing resource use can be identified rapidly and automatically by an alerting system that is configured to notify users when this is the case. Second, a recommendation system can proactively observe patterns of actual computing resource utilization and recommend modifications or alternative arrangements that are more efficient (e.g., by reducing underuse or overuse). Third, the recommendation system can estimate an indirect carbon footprint for an organization's particular uses of computing resources and suggest different sets of hardware that can accomplish the same or similar goals in a more energy-efficient fashion.

Further, when a blockchain is used to store the records of computing resource utilization, the blocks of the blockchain are effectively tamper-proof, as a blockchain provides a distributed, cryptographically immutable storage system. Thus, any determinations of the alerting system or the recommendation system can be made with a high degree of confidence that the underlying data is accurate. Moreover, use of blockchain or time series database technologies arranges the usage data in a time ordering that is easier to index and search, again reducing load on processors and memory.

Other technical improvements may also flow from these embodiments, and other technical problems may be solved. Thus, this statement of technical improvements is not limiting and instead constitutes examples of advantages that can be realized from the embodiments.

### II. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. EXAMPLE COMPUTING DEVICES AND CLOUD-BASED COMPUTING ENVIRONMENTS

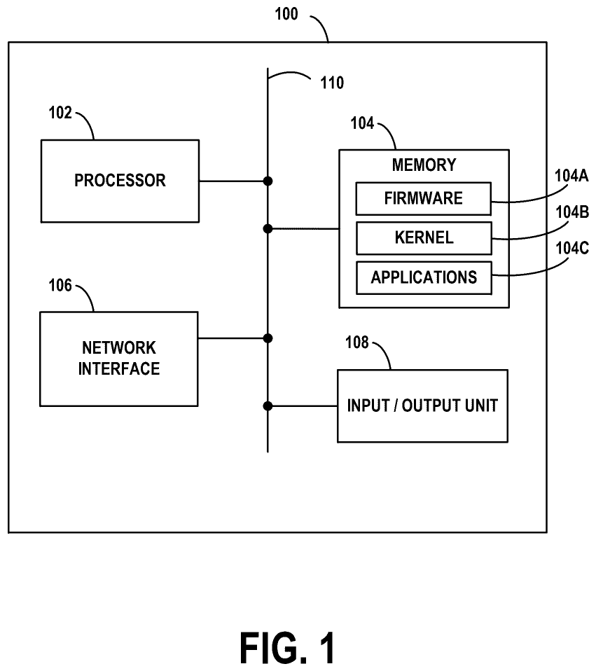

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

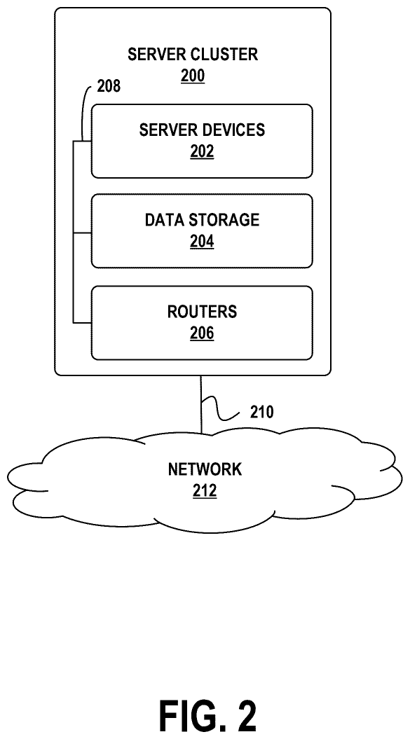

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. EXAMPLE REMOTE NETWORK MANAGEMENT ARCHITECTURE

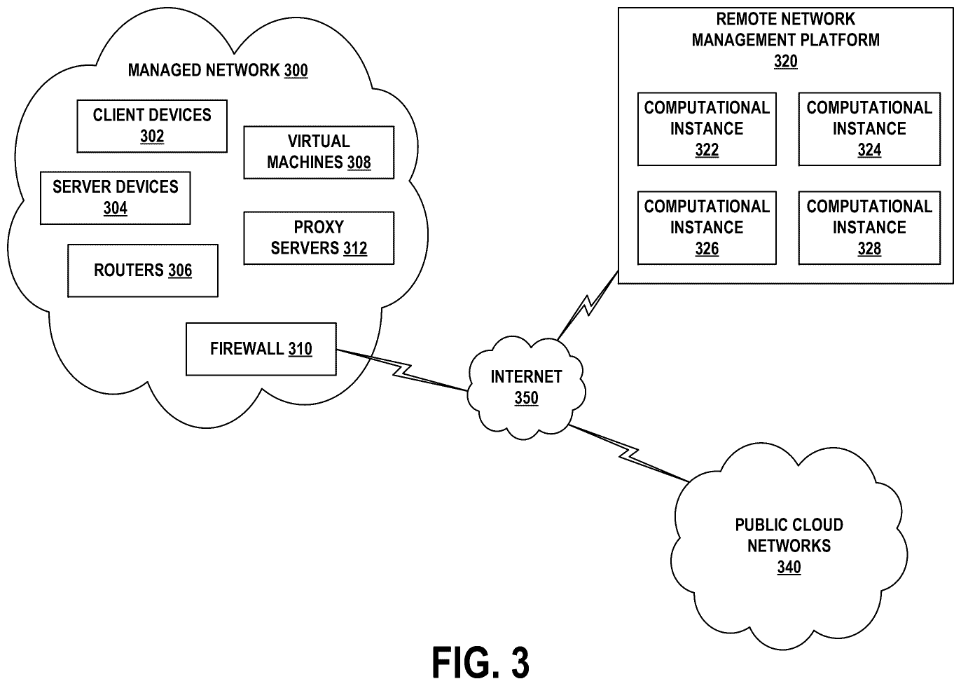

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

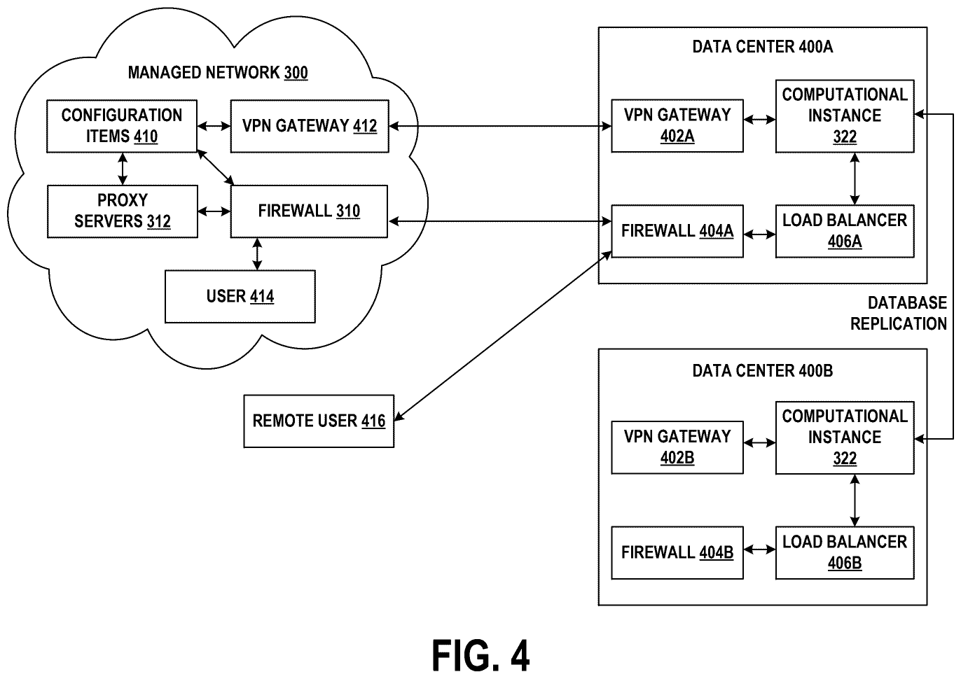

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. EXAMPLE DISCOVERY

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

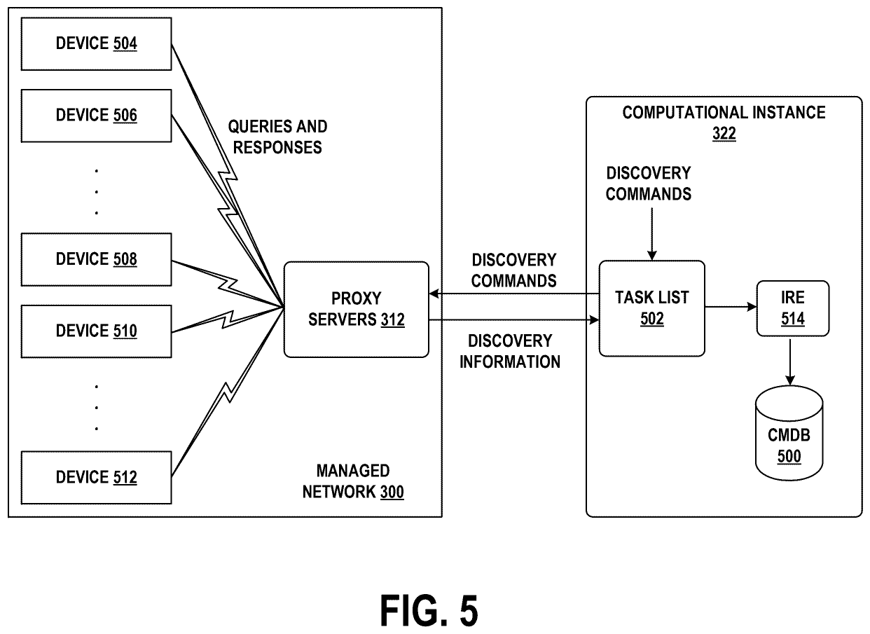

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB IDENTIFICATION RULES AND RECONCILIATION

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. USE OF CLOUD-BASED COMPUTING RESOURCES

As noted above, the computing resources of a public cloud network 340 may be employed by an organization (e.g., managed network 300). These computing resources may include compute power, storage capacity, networking arrangements, data analytics, and/or artificial intelligence/machine learning (AIML) models. Doing so offloads the computing resources of the organization, reduces the need to configure, manage, and maintain dedicated computing resources by the organization, and can scale with demand.

Here, the term “organization” will be used to refer to one or more users of cloud-based platforms. These users may be affiliated in some fashion, either by way of a formal entity (e.g., a corporation or partnership) or otherwise. Thus, an “organization” is a term used for purposes of convenience and should be viewed as non-limiting.

Compute power may include virtual machines (emulations of physical computers, each running its own operating system and applications, isolated from other virtual machines), containers (virtualized applications and their corresponding dependencies that are lightweight, require less startup time than virtual machines, and can provide consistent operation across different computing environments), and/or serverless computing (software that is executed in response to events, scaling automatically with workload and not requiring a full server device or virtual machine).

Storage capacity may include object storage (data that is managed as objects within a flat address space in a manner that is highly scalable), block storage (data that is divided into fixed-sized blocks, which are represented as individual hard drives), and/or file storage (data is stored in files within a hierarchy of folders or directories). Storage capacity may also include databases, such as SQL, NoSQL, and in-memory databases. SQL databases are relational, structured to store data in tables with predefined schemas, and utilize SQL for defining and manipulating data. NoSQL databases are non-relational, designed for flexible data storage models such as key-value, document, graph, or wide-column stores, and suitable for handling large volumes of unstructured data and providing scalability in distributed environments. In-memory databases store data directly in RAM, offering extremely fast data access and processing speeds.

Networking arrangements may include virtual private clouds (providing a logically isolated section of the cloud where resources can be deployed in a pre-defined virtual network), and/or content delivery networks (distributed networks of servers that efficiently delivers web content and services to users based on their geographic location among other factors).

Data analytics may include data warehousing services (used for storing, analyzing, and reporting large datasets and thus supporting complex data queries, data mining, and predictive analytics) and/or big data processing frameworks (services used for processing large sets of data across many servers including capabilities to perform map-reduce tasks and handle vast amounts of data in a distributed manner).

AIML models may include machine learning platforms that provide pre-trained models as a services that generate predictions based on input data. These services can include speech recognition, text analysis, or image processing, for example. For more intensive computations, especially training deep learning models, cloud platforms may provide access to graphical processing units (GPUs) and tensor processing units (TPUs) to provide hardware acceleration of calculations. AIML models may also include generative AI models, such as large language models and/or diffusion models.

Organizations may access a cloud computing platform and control their usage thereof by way of one or more accounts. These accounts may require username/password authentication to log on, or other more secure authentication methods, such as multi-factor authentication. In some cases, an organization may have multiple accounts that are tied together in some fashion, with each account potentially having a different set of permissions. By way of such an account, the account holder can deploy and manage cloud-based computing resources and services, control user roles and permissions of other accounts, establish monitoring of cloud-based computing resource allocation, backup and restore data, and so on.

A technical challenge that stems from the deployment and use of cloud-based computing resources is that it can be prohibitively complex to manage, track, or even understand which types of computing resources and how many of each type are being used. Many cloud-based platform providers offer monthly or periodic reports that enumerate the utilization of computing resources per type on an hourly basis.

The problem with such a detailed report is twofold. First, even for modest cloud-based platform usage, the reports are exhaustive to the point that they cannot be understood by humans. For example, a monthly report for a typical mid-sized organization that uses a cloud-based platform may include hundreds of thousands of individual entries. The second problem is that cloud providers may offer various packages that incentivize organizations to deploy and use cloud-based computing resources in certain patterns. Thus, it can be advantageous for one to use more of certain types of computing resources than others. For example, reserved instances provide dedicated computing resources for an extended period of time (e.g., 1-3 years) while non-reserved (on-demand) computing resources are not guaranteed to be available during periods of peak utilization.

But these incentives are typically not made explicit in the reports. Furthermore, organizations may attempt to manage their computing resource utilization on a daily basis. However, the cloud based platforms may not offer accurate utilization information for up to 48 hours, resulting in an attenuated feedback loop with which organizations cannot respond quickly enough to changing levels of demand.

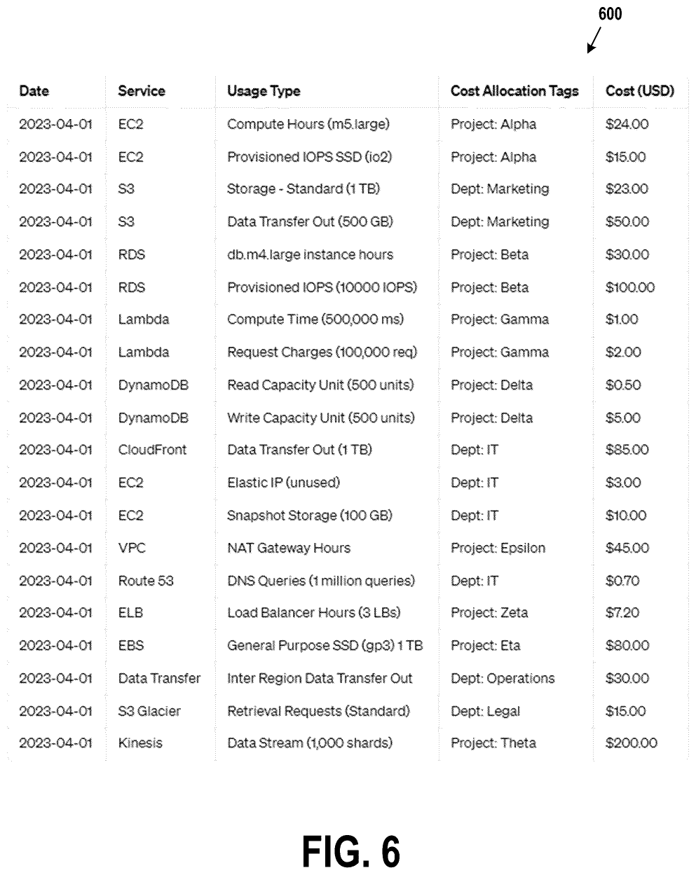

For purposes of example, a fictionalized computing resource usage report 600 is shown in FIG. 6. This report is based on hypothetical usage of the Amazon AWS cloud platform. Some of these computing services provided by this platform include including EC2 for scalable computing, S3 for object storage, RDS for managed relational databases, Lambda for serverless computing, DynamoDB for NoSQL database services, VPC for isolated network provisioning, Route 53 for DNS web service, EBS for block storage, S3 Glacier for long-term archival storage, and Kinesis for real-time data streaming and analytics. For example, the first entry in report 600 indicates that on Apr. 1, 2023 the organization used $24 worth of computing time on an EC2 instance for its project alpha. In some cases that are not shown in FIG. 6, report 600 may include an indication of an account that allocated or is managing the utilized computing resources for each line item.

Report 600 only contains 20 entries for a given day (an actual report may contain thousands of entries for such a day). But even in this abbreviated form, it is difficult if not impossible for one to determine whether and where the organization's use of the cloud-based computing resources is inefficient, much less what can be done to improve its efficiency. Further and as shown, some usage reports may include billing information, such as costs per unit of computing resources utilized. This information could also be taken into account when determining inefficiencies in computing resource utilization.

As a result, most organizations' use of cloud-based computing resources remains inefficient. These inefficiencies may include over-provisioning of computing resources (e.g., allocating more computing resources than necessary for their applications), underutilization of reserved instances (e.g., securing reserved instances that do not match actual usage patterns), idle resources (e.g., sets of computing resources left operational 24 hours a day when they are only used during certain hours), inefficient data storage (e.g., storing redundant data without a clear need to do so, or storing infrequently accessed data in high-performance storage systems instead of in cold or archival storage), and/or poorly managed scaling (e.g., using incorrect auto-scaling parameters).

These are just a few observations of how cloud-based computing resources are inefficiently allocated and deployed, and there may be others. Therefore, it would be desirable for organizations to be able to more efficiently manage their computing resource utilization so that waste of these resources can be mitigated.

### VIII. BLOCKCHAIN AND OTHER STORAGE TECHNOLOGIES

In order to provide solutions to technical problems related to inefficient use of cloud-based computing resources, the implementations described herein may employ various storage technologies to maintain accurate histories of computing resource usage reports. Storing the usage reports in such a manner facilitates various activities that can be employed to determine inefficiencies in the use of the computing resources. These storage technologies may include cryptographically immutable storage techniques, such as blockchains, time series databases, SQL and NoSQL databases, distributed file systems, and so on.

Blockchain-based technology underlies and facilitates a form of decentralized computing that has been used to provide cryptocurrencies, smart contracts, non-fungible tokens (NFTs), identity protection, and secure voting, among many other applications. There is speculation, at least from some sources, that a new version of the world-wide web (“web 3.0”) can be built atop one or more blockchains. Herein, “blockchain-based” technology refers to any variation of blockchain technology or any technology that employs or relies upon blockchain mechanisms. This includes current and future variations of blockchain technology.

In short, a blockchain is a list of records stored as a distributed database that can grow over time based on consensus protocols carried out by blockchain nodes. Groups of records are added to the blockchain within data structures that take the form of blocks, and sequential blocks are cryptographically linked to one another. Each block may contain one or more records.

The blockchain nodes are computing devices or computing systems that can communicate with one another in a peer-to-peer fashion using blockchain software, and thus may reside in different locations and may even be operated by different entities. Blockchain nodes may form an overlay on an existing computer network (e.g., the Internet) and may be jointly referred to as a blockchain network. To maintain independence and the decentralized character of the blockchain, each blockchain node may store its own copy of the entire blockchain or at least part thereof.

Each block contains a cryptographic hash of the previous block in the blockchain, a timestamp, and data. The cryptographic hash may be produced by any one-way (hash) function that is mathematically and/or computationally impractical to reverse, such as SHA-256, SHA-512, RIPEMD-160, or Whirlpool. The sequential linking of blocks through a cryptographic hash chain makes it difficult for any party to modify a recently-placed block, and virtually impossible to modify earlier blocks. With such a property, blocks in a blockchain may be referred to herein as “cryptographically secure” or “cryptographically-immutable.”

Each blockchain user has a unique address to use with the blockchain. Each user also has a public key/private key pair that is cryptographically associated such that data encoded with the public key can be only be decoded by the corresponding private key, and vice versa. Thus, data encoded with a user's public key are effectively encrypted so that they can only be decrypted by the user's private key, and data encoded with the user's private key results in a digital signature that is verifiable with the user's public key.

A record is typically some form of transaction between two or more users that includes the address of the “sending” user, the information being “sent,” and the address of one or more “receiving” users, all of which is signed with the digital signature of the sending user. Thus, the record can easily be verified to be from the sending user (the sending user is authenticated) and have integrity (the record was not changed after signing) as well as non-repudiation (the sender cannot later deny having signed the record). In some cases, the sender or receiver may be non-human (e.g., a smart contract, a machine learning model, or software in general). In the embodiments herein, the sender can be a cloud-based service provider or the organization operating the remote network management platform.

The information being sent can take various forms. Traditionally, it has been some amount of cryptocurrency, input for a smart contract, or some other token. For the implementations herein, a record in a blockchain may include a representation of one or more one or more entries in a usage report from a cloud-based platform. But other arrangements are possible.

Proposed new records are received by one or more blockchain nodes and their digital signatures may be authenticated. In some cases, the validity of each proposed record may also be verified based on the purpose of the blockchain (e.g., a record on a blockchain that stores computing resource usage data typically cannot indicate a negative amount of usage). These records are formed into blocks, and then the blocks are distributed across the blockchain network to the other blockchain nodes. As noted above, each block may include one or more records.

In some cases, each blockchain node independently authorizes received records through an agreed-upon consensus protocol. An example of such a protocol is “proof of work,” where the blockchain nodes attempt to solve a mathematical puzzle by trial and error. For instance, the consensus protocol may require that the blockchain nodes attempt to find a nonce (e.g., an unknown value) such that a cryptographic hash function performed over the block with the nonce appended results in a hash value with a specified number of leading zeros. The process of carrying out this protocol is often referred to as “mining”.

The first blockchain node that discovers a suitable nonce broadcasts this nonce and the resulting hash value to the rest of the blockchain network. It is trivial for the other blockchain nodes (e.g., validators) to validate whether the nonce and hash value are correct by simply applying the hash function. Such a block is said to have been “mined”. Once a simple majority of the blockchain nodes agree that the block has been mined, the block is added to the blockchain by all blockchain nodes. Note that not all blockchain nodes need to act as miners in this fashion.

The cryptographic linking of blocks, as well as a proof of work protocol being used for consensus, makes illegitimate modifications of a blockchain to be practically infeasible, as an attacker must modify all subsequent blocks in order for the modifications of one block to be accepted. Thus, blocks on a blockchain are considered to be backwardly-immutable. Nonetheless, other consensus protocols, such as those based on proof of stake, may be used instead.

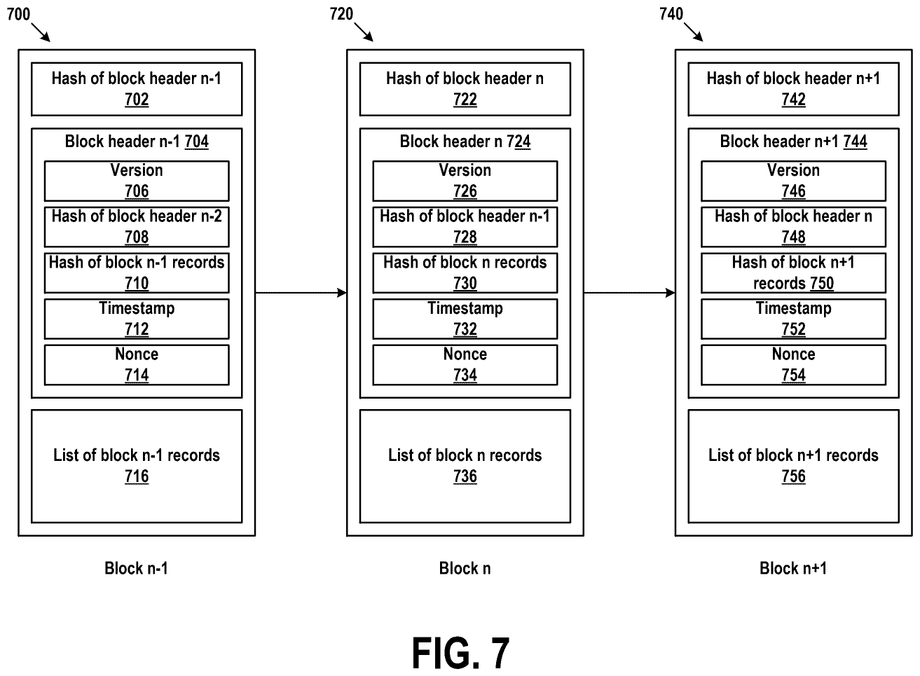

FIG. 7 provides an example of blockchain data. In this example, three sequential blocks of a blockchain are shown, blocks 700, 720, and 740. In terms of the sequential relationship between these blocks, block 700 may also be referred to as block n−1, block 720 may also be referred to as block n, and block 740 may also be referred to as block n+1. Thus, block n−1 appears immediately before block n in the ordering of the blockchain, and block n appears immediately before block n+1 in the ordering of the blockchain. An arbitrary number of blocks may precede block n−1 and an arbitrary number of blocks may follow block n+1.

Each of the blocks may include three main parts. Thus, block 700 includes hash 702, block header 704, and records 716. Likewise, block 720 includes hash 722, block header 724, and records 736, and block 740 includes hash 742, block header 744, and records 756. Hash 702 is the resulting hash value from applying a hash function to block header 704, hash 722 is the resulting hash value from applying a hash function to block header 724, and hash 742 is the resulting hash value from applying a hash function to block header 744. It is presumed that the same hash function is used for each of these operations, though it is possible to eliminate this presumption. Records 716, 736, and 756 are respective lists of records within each block.

Block header 704 includes version 706, hash 708 of the previous block header in the blockchain, hash 710 of records 716, timestamp 712, and nonce 714. Version 706 may indicate the version number of the blockchain. If changes are made to how the blockchain operates, version 706 may be modified. Hash 708 is the resulting hash value from applying a hash function to block header n−2. Hash 710 is the resulting hash value from applying a hash function to records 716. Hash 710 may be a Merkle root representation of Merkle tree processing of records 716. Timestamp 712 may be an indication of the time when the block was successfully mined and/or added to the blockchain. Nonce 714 may be the nonce value of the block found during mining.

In a similar fashion, block header 724 includes version 726, hash 728 of the previous block header in the blockchain, hash 730 of records 736, timestamp 732, and nonce 734. Likewise, block header 744 includes version 746, hash 748 of the previous block header in the blockchain, hash 750 of records 756, timestamp 752, and nonce 754.

As noted, this overall data structure has the property that blocks placed on the blockchain are effectively immutable. This is because the each block header contains a hash of its associated records as well as a hash of the previous block header, and then a hash is calculated for the block header itself. These hashes recursively chain the integrity of the blocks so that any attempt to modify a block illegitimately would require modification of all subsequent blocks as well. Such changes would need to be separately made on enough blockchain nodes to cause the consensus protocol to accept the modification. If these blockchain nodes are distributed, independently operated, and/or independently secured, doing so is impractically difficult.

Notably, other data and arrangements thereof can be used in a blockchain while maintaining these desirable properties. Thus, the embodiments herein are not limited to those of FIG. 7.

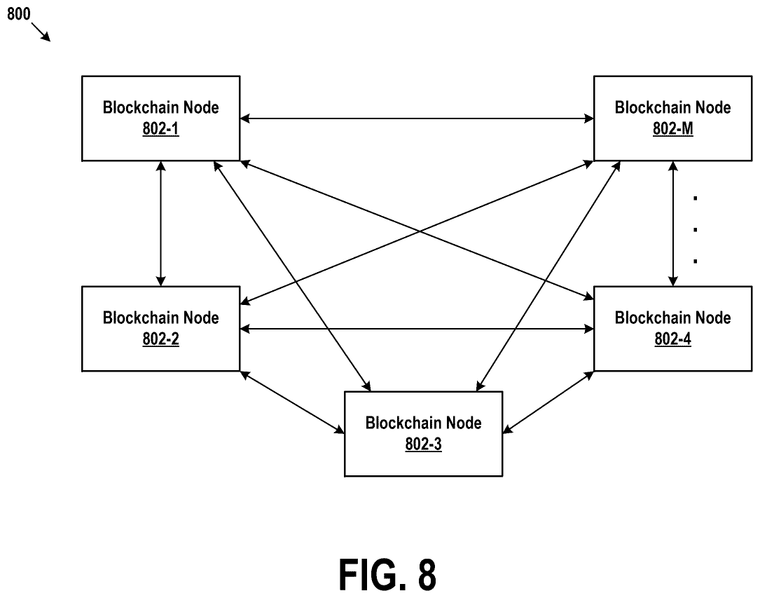

An example network of blockchain nodes is shown in FIG. 8. Blockchain network 800 includes M blockchain nodes 802-1, 802-2, 802-3, 802-4, . . . , 802-M, with the ellipsis indicting that any number of blockchain nodes may be included. As noted, these blockchain nodes operate in a peer-to-peer fashion, with each blockchain node broadcasting the results of mined blocks to the other nodes and following a consensus protocol to determine which blocks are ultimately placed on the blockchain. Also as noted, each blockchain node may store an entire copy of the blockchain. Thus, a blockchain network is a form of redundant distributed database.

One of the major uses of blockchain technology, in addition to the use described above, is the formation and execution of smart contracts. Smart contracts are executable logic (e.g., programs or code snippets) that are placed in records. A smart contract's logic is executed when certain predetermined conditions are met. A simple smart contract may consist of “if-X-then-Y” logic, where X is a set of one or more conditions and Y is a set of one or more operations to be carried out when X becomes true.

Smart contracts typically exist as records on a blockchain employing “server” functionality outside of the direct control of users of the blockchain (i.e., a user may write and deploy a smart contract, but then the smart contract operates as programmed even if the user decides later that they do not approve of the smart contract). Users interact with a smart contract by submitting data that cause execution of functions defined by the smart contract. Smart contracts can define rules and automatically enforce these rules via programmatic logic (e.g., software code). Smart contracts typically cannot be deleted, and interactions with them are generally irreversible. The operations of a smart contract may involve the smart contract generating output, including possibly adding one or more further records to the blockchain.

An implementation of smart contracts is the Ethereum ERC-20 standard. It defines an application programming interface (API) through which smart contracts are specified, queried, and executed. The mechanism through which ERC-20 does so is contract-defined tokens that can be transferred between users of the blockchain. These tokens may have some associated value or inherent sematic meaning to user or software applications that interact with the blockchain. Such tokens are identified by the address of the ERC-20 smart contract in which they are defined, and thus are essentially a string of bits that is unique per blockchain.

As an example, ERC-20 smart contract logic may specify that when a condition specified by the smart contract (X) becomes true, the smart contract will create a record on the blockchain indicating that the user has been granted a certain permission (Y). Determining whether the condition (X) is true may require data from an off-chain source, e.g., a weather report, an account balance, sensor data, etc. Since blockchains are fundamentally deterministic and conditional data is likely to change over time, an oracle is used to obtain off-chain data as needed.

Oracles are decentralized on-chain APIs that can obtain off-chain data from multiple sources. In some cases, oracles can send data to off-chain recipients. Oracles use consensus protocols to determine which off-chain data source is accurate at a given point in time, and then write this data to the blockchain. Doing so mitigates the possibility that one or more of the off-chain data sources gets hacked or otherwise subverted, as the consensus protocol will select the majority or plurality of data sources that agree.

In other words, an oracle is a distributed application that, when invoked, writes “trusted” data to the blockchain. This data then becomes an immutable record of the value of corresponding off-chain data at a given point in time. For instance, if an oracle is called at noon on Mar. 13, 2024 to obtain the temperature in a particular geographic location, the oracle accesses one or more external APIs to do so (e.g., obtaining and parsing weather data from governmental and/or commercial sources), follows the consensus protocol to determine the “trusted” temperature, and writes this “trusted” temperature to the blockchain. Then, any smart contract with a condition (X) that requires knowing the temperature in the particular geographic location at noon on Mar. 13, 2024 can read this blockchain record at any time in the future.

Alternatively or additionally, off-chain software tools may be used to check the status of a smart contract and then add records as necessary for operations (Y). In some cases, these further records may also be smart contracts with different sets of conditionally-executable logic. Thus, smart contracts can be chained to perform a complex series of operations.

The discussion so far in this section focuses on blockchain-based technologies. But cloud-based platform computing resource usage entries can be stored as records of other types of data structures and arrangements.

For example, a time series database is a specialized database configured to efficiently store information in the form of sequences of data points indexed in time order. Time series data can be found in applications such as environmental monitoring and performance tracking for IT systems. Time series databases are designed to efficiently collect, store, and query large volumes of time-stamped data. They differ from traditional relational databases in several ways, focusing on speed and efficiency for both data ingestion and retrieval. In particular, each data point may have a timestamp associated with it, indicating the exact or relative time at which the data was recorded. This allows the time series database to efficiently organize data in chronological order for rapid indexing and random-access retrieval (e.g., of entries within a specific time range).

Nonetheless, SQL or NoSQL databases could be used instead. Further, monolithic or distributed file systems could be used with the data points being grouped (chronologically or otherwise) in one or more files.

### IX. EXAMPLE COMPUTING RESOURCE USAGE ANALYSIS ARCHITECTURE

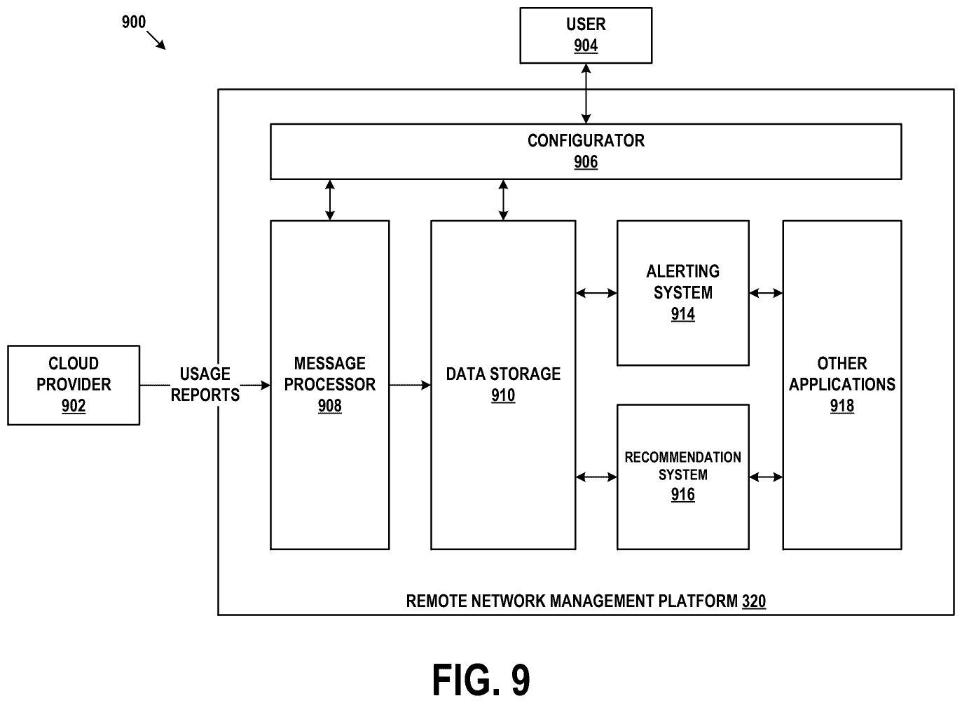

FIG. 9 depicts an example architecture 900 configured to analyze computing resource usage. Architecture 900 includes cloud provider 902, user 904, configurator 906, message processor 908, data storage 910, alerting system 914, recommendation system 916, and other applications 918. As shown, all of these components may be software and/or hardware disposed upon remote network management platform 320 (e.g., as part of a computational instance). But other arrangements are possible.

Cloud provider 902 may be one or more cloud-based platforms that provide remote network management platform 320 access to computing resources. As discussed above, these computing resources may include compute power, storage capacity, networking arrangements, data analytics, and/or AIML models. Also, as shown in FIG. 9, cloud provider 902 may transmit or otherwise make available usage reports that reflect the computing resource usage attributable to remote network management platform 320. These usage reports may be in the form of computing resource utilization report 600 or arranged in another format. Regardless, entries of the usage reports may include representations of each computing resource used, its type, the date it was used, the volume of usage, and/or other information.

User 904 may be any user of remote network management platform 320 that has access to configurator 906. In some cases, user 904 may be an administrative user who controls and/or monitors the operation of various components of architecture 900.

Configurator 906 may be one or more software applications that can be used to control and/or monitor the operation of various components of architecture 900. While FIG. 9 depicts configurator 906 as able to interact with message processor 908 and data storage 910, configurator 906 may also be able to control and/or monitor the operation of alerting system 914 and recommendation system 916, for example. To do so, configurator 906 may include a user interface through which user 904 can set parameters and policies, display real-time or non-real-time status and/or performance information (including alerts and/or notifications), manage backups, and/or manage security settings.

Message processor 908 may be one or more software applications that provide a processing framework for stateless or stateful computations over unbounded and bounded data streams. Message processor 908 may be capable of handling very high volumes of data in real-time, such as large usage reports. Message processor 908 may be able to perform event time processing of data based on the time it was actually created rather than when it was received by message processor 908. This feature facilitates the handling of out-of-order entries in usage reports. Message processor 908 may also be configured for fault tolerance, and be capable of scaling across multiple physical or virtual computing devices so that it can process large workloads. An example embodiment of message processor 908 is Apache's Flink, but other systems can be used. For instance, Flink may be able to efficiently convert usage reports (which are typically in comma-separated-value (CSV) or JSON format) into individual line items for each entry. Advantageously, message processor 908 may able to distribute tens of thousands of usage report entries across one or more structures within data storage 910.

Data storage 910 may include one or more blockchains, time series databases, SQL databases, NoSQL databases, and/or distributed file systems. But other types of data storage are possible.

In the case of blockchain, for example, data storage 910 may include one or more blockchain nodes (e.g., miners, validators, or storage) that each store a partial or complete copy of a blockchain. These nodes may be distributed across a single remote network management platform or multiple remote network management platforms (e.g., across one or more data centers). Data storage 910 may receive entries from message processor 908, possibly in time order. Referring again to FIG. 6, the entries may also be chronologically-ordered but separated by service, usage type, allocation tag, or usage volume. For example, a single blockchain may only receive entries of a certain service, usage type, allocation tag, or usage volume, thus resulting in multiple blockchains storing entries relating to different services, usage types, allocation tags, or usage volumes. In some cases, the entries can be group or assigned to a blockchain based on its cloud-based account, the geographic location of the cloud-based service employed, and/or service category (e.g., compute power, storage capacity, networking arrangements, data analytics, and/or AIML models).

As noted above, each block stored on a blockchain may include multiple entries (e.g., 5, 10, 25, 50, 100, or more entries). Accordingly, each block may contain a header describing what is stored in the blocks (e.g., a representation of its entries source(s), service(s), usage type(s), allocation tag(s), and/or total usage volume), a transaction counter (indicating the number of entries in the block), and/or the entries.

The immutable nature of a blockchain makes it virtually infeasible for any one actor to modify data within any of the blocks added to the blockchain. This means that any conclusions or changes based on analysis of the data within these blocks can be made with a very high degree of confidence that the data is valid, accurate, and has not been subject to tampering.

In the case of a time series database, data storage 910 may include one or more of such databases, each storing some or all of the entries provided by message processor 908. These databases may be distributed across a single remote network management platform or multiple remote network management platforms (e.g., across one or more data centers). As in the case of blockchain, the entries may be chronologically-ordered but separated by service, usage type, allocation tag, or usage volume. For example, a single time series database may only receive entries of a certain service, usage type, allocation tag, or usage volume, thus resulting in multiple time series database storing entries of different services, usage types, allocation tags, or usage volumes. Alternatively or additionally, the entries can be grouped or assigned to a time series database based on their associated cloud-based account, the geographic location of the cloud-based service employed, and/or service category (e.g., compute power, storage capacity, networking arrangements, data analytics, and/or AIML models). As noted above, each time series database can be indexed for efficient searching and accessing entries within a specific time range.

Alerting system 914 may be configured to scan entries of usage reports disposed within data storage 910 (e.g., by traversing the blocks of a blockchain or querying specific date ranges of records in a time series database) and detect abnormal patterns of usage that may subsequently be brought to the attention of user 904. Some of these abnormal patterns may be usage based, off-hours based, or consumption based, for example. Any alert generated by alerting system 914 may be provided to user 904 or any other user by way of configurator 906 or some other channel (e.g., email, text message, notification, etc.).

Usage based alerts may involve an organization specifying or otherwise providing a list of services they use. This list of services may be service categories, usage types, and/or allocation tags as just some examples. If a time-range of entries (e.g., entries between a first time t1 and a second time t2) contains an indication of any other service being used (e.g., a proscribed service), alerting system 914 may generate an alert regarding the usage of non-listed services. Usage based alerts may include spending based alerts that are triggered when a service-level consumption reaches or is about to reach a predetermined threshold (e.g., a cost of over $2000 in a single day across all computing resources).

As one example, an organization might specify in alerting system 914 (e.g., by way of configurator 906) that the only type of cloud-based storage that it should use is S3 object storage. Alerting system 914 may periodically or from time to time read and analyze the services used by recent records placed in data storage 910 (e.g., the records placed there since the last time alerting system 914 performed such an analysis). If these records reflect use of storage other than S3 object storage (e.g., S3 Glacier cold storage), alerting system 914 may generate an alert indicating that this is the case.

Off-hours based alerts may be generated when computing resources remain allocated even though the majority of their potential users are not working for the organization at that time. For example, if an organization's employees are expected to only use cloud-based computing resources during normal business hours (e.g., 7 am-7 pm), any significant computing resources that remain allocated or reserved outside of this window are likely to remain underutilized.

As one example, an organization might specify in alerting system 914 (e.g., by way of configurator 906) that no more than 1 hour total of EC2 computing power should be used between 7 pm and 7 am on weekdays and not at all on weekends. Alerting system 914 may periodically or from time to time read and analyze the EC2 usage appearing in records placed in data storage 910 that are from these time periods. If these records reflect more than one hour of EC2 use in these time periods, alerting system 914 may generate an alert indicating that this is the case.

Consumption based alerts may be generated when computing resources are over-allocated or under-allocated in comparison to actual usage. For example if the utilization of an EC2 or RDS instance is below 20% over a pre-defined period of time (e.g., one or more days), that instance is likely under-utilized. On the other hand, if the utilization of an EC2 or RDS instance is above 80% over the period of time, that instance is likely over-utilized. An organization may set similar low-water marks (e.g., 10-30%) and high-water marks (e.g., 70-90%) for various resource utilizations.

As one example, an organization might specify that its EC2 usage should always be between 10% and 90% of capacity when averaged over the course of day. Alerting system 914 may periodically or from time to time read and analyze the EC2 usage appearing in records placed in data storage 910 that are from each day. If these records reflect an average EC2 utilization of less than 10% or greater than 90%, alerting system 914 may generate an alert indicating under-utilization or over-utilization, respectively.

Notably, the definitions of usage, off-hours, and consumption based alerting may overlap to some extent-off-hours and consumption based alerts may be generated based on certain patterns of usage. Thus, these three categories of alerts are not mutually exclusive. Further, in some cases, alerts may apply only to records with certain allocation tags (e.g., relating to particular unit or projects within the organization), geographical locations, or that were used by certain accounts.

Recommendation system 916 may be configured to scan entries of usage reports disposed within data storage 910 (e.g., by traversing the blocks of a blockchain or querying specific date ranges of records in a time series database) and determine modifications to an organization's use of cloud-based platform computing resources that may be brought to the attention of user 904. These modifications may include allocating more or fewer computing resources, or changing the type of computing resource or package of computing resources used. Any recommendation generated by recommendation system 916 may be provided to user 904 or any other user by way of configurator 906 or some other channel (e.g., email, text message, notification, etc.).

Usage configuration recommendations may be generated when recommendation system 916 determines that actual computing resource utilization warrants at least partially replacing current computing resource allocation with a different allocation or package. For example, recommendation system 916 might perform a trend analysis (e.g., identifying patterns of computing resource usage over time, such as peak usage hours or idle times), a usage volume analysis (e.g., how much of various types of computing resources are being used), or a spending analysis (e.g., comparing current costs with potential costs of alternative configurations of computing resources to find less expensive options that meet usage need). Such an analysis may employ various machine learning models or other techniques.

If recommendation system 916 determines that computing resources could be more efficiently allocated, it may generate recommendations of how to do so. This could include, for example, changing instance types or sizes based on actual usage (e.g., if an EC2 instance consistently uses a small fraction of its allocated computing resources, the recommendation system 916 might suggest a smaller instance type). Another type of recommendation may be adjusting computing resources allocated to RDS or shifting to a different database instance class to better match the usage characteristics. A further type of recommendation may involve changes to EBS volume types and configurations to improve performance (e.g., moving from provisioned input/output operations per second to general purpose SSD storage on actual I/O operations). Yet another type of recommendation may involve modifying auto scaling settings to better align with usage patterns (e.g., suggesting more aggressive scaling during peak hours and scaling down during off-peak times). Other possibilities exist.

Carbon footprint recommendations may be generated when recommendation system 916 determines, from the usage reports, that an organization's carbon footprint can be reduced by changing its cloud-based platform computing resource usage. Notably, organizations are becoming more concerned with their type-3 carbon emissions, such as indirect emissions based on activities upstream or downstream to those of the organization. Cloud-based services fall into the category of indirect emissions since the organization is indirectly causing the usage of computing resources, and such usage can incrementally impact the carbon footprint of the cloud-based provider.

To do so, some cloud-based providers offer carbon footprint tools that are software applications configured to estimate an organization's carbon footprint. If these tools are not available, the carbon footprint can be estimated by: identifying the computing resources being used (e.g., processor types, hard drives, solid state drives, network capacity), estimating the energy consumption of these computing resources (e.g., based on the power usage effectiveness of the data center providing the computing resources including that of cooling apparatuses), determining the source of the electricity used by the computing resources (e.g., renewables, fossil fuels, or nuclear), and calculating the carbon emissions (e.g., average emissions per unit of electricity-generated kilograms of CO2 per kilowatt-hour). Other indirect emissions may be considered, such as those used to manufacture the computing hardware at the data center as well as emissions due to transportation of this hardware to the data center.

Recommendation engine 916 may be configured to estimate the CO2 per kilowatt-hour produced by the organization's usage of computing resources and recommend other configurations (if applicable) that can reduce the carbon footprint. For example, recommendation engine 916 may recommend switching to newer, more efficient processors that use less energy per operation or generate less heat per operation. Alternatively or additionally, recommendation engine 916 may recommend moving to solid state drives from hard drives, as solid state drives may be able to exceed the read/write performance of hard drives while using about three times less energy and generating less heat. Other possibilities exist.

Alerting system 914 and/or recommendation system 916 may be triggered to operate upon the addition of a new block to a blockchain, the addition of n blocks to the blockchain, or the addition of a threshold number of records to either a blockchain, a time series database, or any other data structure in which records are stored. Alternatively or additionally, alerting system 914 and/or recommendation system 916 may be triggered to operate based on time, such as once per hour, once per day, once per week, etc.

Further, alerting system 914 and/or recommendation system 916 may operate in a closed loop fashion with respect to the cloud-based platform. For instance, the organization may specify certain conditions that, when met, cause alerting system 914 and/or recommendation system 916 to modify the allocation of computing resources on the platform. As an example, the organization may specify that if the utilization of dedicated processors remains below 20% for three days or more, alerting system 914 and/or recommendation system 916 may automatically deallocate up to 50% of the dedicated processors. Similar modifications can be made if storage capacity remains below a threshold value for some period of time.

Other applications 918 may include any additional application on remote network management platform 320 that may interact with alerting system 914 and/or recommendation system 916. These may include, for example, security applications, energy management applications, automation applications, and capacity planning applications, for example.

### X. EXAMPLE OPERATIONS

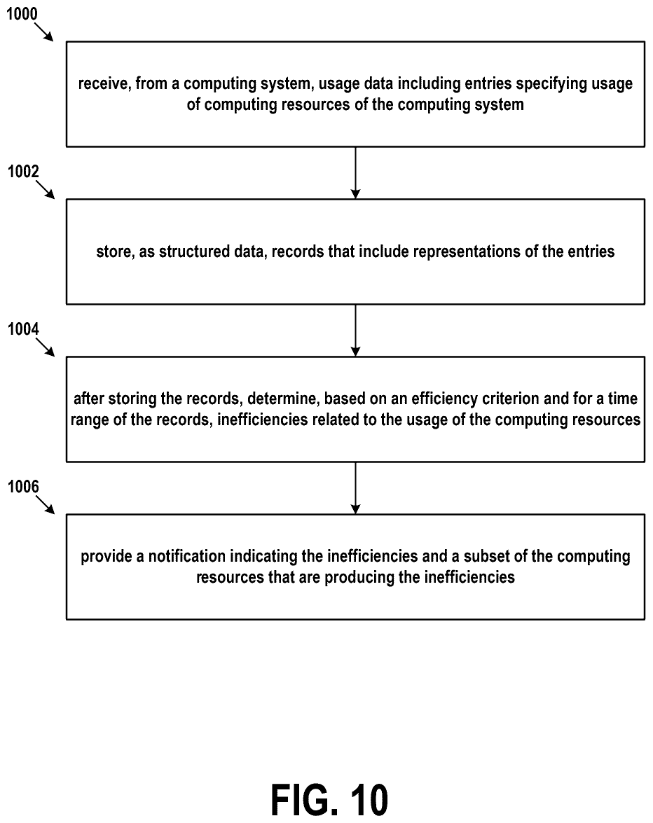

FIG. 10 is a flow chart illustrating an example embodiment. The process illustrated by FIG. 10 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 10 may be simplified by the removal of any one or more of the features shown therein. Further, these embodiments may be combined with features, aspects, and/or implementations of any of the previous figures or otherwise described herein.

Block 1000 may involve receiving, from a computing system, usage data including entries specifying usage of computing resources of the computing system.

Block 1002 may involve storing, as structured data, records that include representations of the entries.

Block 1004 may involve, after storing the records, determining, based on an efficiency criterion and for a time range of the records, inefficiencies related to the usage of the computing resources. Identifying inefficiencies related to the usage of the computing resources provides a technical improvement over the state of the art. Previously, the allocations of computing resources were reviewed rarely and thus inefficiencies remained in place for long periods of time. In many practical situations, the usage reports were so long and complex that it was difficult if not impossible to determine whether inefficiencies even exist.

Block 1006 may involve providing a notification indicating the inefficiencies and a subset of the computing resources that are producing the inefficiencies. Providing this notification results in a technical improvement over the state of the art. Previously, it was impractical to identify the inefficiencies, as the usage reports were long and complex. Moreover, with the inefficiencies identified, steps can be taken to mitigate their impact.

Some implementations may further involve modifying, by way of remote access to the computing system, future use of the subset of the computing resources so that the inefficiencies are reduced.

In some implementations, the structured data includes a distributed, cryptographically immutable sequence of blocks containing the records.

In some implementations, the structured data includes a time series database containing the records.

In some implementations, determining the inefficiencies related to the usage of the computing resources comprises an alerting system detecting abnormal patterns of the usage in the time range of the records, wherein providing the notification indicating the inefficiencies and the subset of the computing resources that are producing the inefficiencies comprises the alerting system providing an alert relating to the abnormal patterns of the usage.

In some implementations, the abnormal patterns of the usage in the time range of the records include the usage of computing resources associated with a service other than a pre-defined set of allowed services, wherein the subset of the computing resources includes the computing resources associated with the service.

In some implementations, the abnormal patterns of the usage in the time range of the records include usage of computing resources outside of a pre-defined set of hours, wherein the subset of the computing resources includes the computing resources used outside of the pre-defined set of hours.

In some implementations, the abnormal patterns of the usage in the time range of the records include under-utilization or overutilization of computing resources in comparison to one or more pre-defined threshold levels of utilization, wherein the subset of the computing resources includes the computing resources that are under-utilized or over-utilized.

In some implementations, determining the inefficiencies related to the usage of the computing resources comprises a recommendation system detecting the inefficiencies, wherein providing the notification indicating the inefficiencies and the subset of the computing resources that are producing the inefficiencies comprises the recommendation system providing a recommendation to modify an allocation of the computing resources.

In some implementations, the inefficiencies are detected based on a trend analysis or volume analysis of the usage of the computing resources, wherein the recommendation to modify the allocation of the computing resources comprises a suggestion to change a type or quantity of the computing resources used.

In some implementations, the inefficiencies are detected based on a carbon footprint analysis of the usage of the computing resources, and wherein the recommendation to modify the allocation of the computing resources comprises a suggestion to replace at least some of the computing resources with more power efficient computing resources.

In some implementations, determining the inefficiencies related to the usage of the computing resources is caused by addition of a pre-determined number of the records to the structured data.

### XI. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media like register memory, processor cache, RAM, ROM, optical or magnetic disks, solid-state drives, or compact disc read only memory (CD-ROM), for example. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving, from a computing system, usage data including entries specifying usage of computing resources of the computing system;
storing, as structured data, records that include representations of the entries;
after storing the records, determining, based on an efficiency criterion and for a time range of the records, inefficiencies related to the usage of the computing resources; and
providing a notification indicating the inefficiencies and a subset of the computing resources that are producing the inefficiencies.

2. The method of claim 1, further comprising:
modifying, by way of remote access to the computing system, future use of the subset of the computing resources so that the inefficiencies are reduced.

3. The method of claim 1, wherein the structured data includes a distributed, cryptographically immutable sequence of blocks containing the records.

4. The method of claim 1, wherein the structured data includes a time series database containing the records.

5. The method of claim 1, wherein determining the inefficiencies related to the usage of the computing resources comprises an alerting system detecting abnormal patterns of the usage in the time range of the records, and wherein providing the notification indicating the inefficiencies and the subset of the computing resources that are producing the inefficiencies comprises the alerting system providing an alert relating to the abnormal patterns of the usage.

6. The method of claim 5, wherein the abnormal patterns of the usage in the time range of the records include the usage of computing resources associated with a service other than a pre-defined set of allowed services, and wherein the subset of the computing resources includes the computing resources associated with the service.

7. The method of claim 5, wherein the abnormal patterns of the usage in the time range of the records include usage of computing resources outside of a pre-defined set of hours, and wherein the subset of the computing resources includes the computing resources used outside of the pre-defined set of hours.

8. The method of claim 5, wherein the abnormal patterns of the usage in the time range of the records include under-utilization or overutilization of computing resources in comparison to one or more pre-defined threshold levels of utilization, and wherein the subset of the computing resources includes the computing resources that are under-utilized or over-utilized.

9. The method of claim 1, wherein determining the inefficiencies related to the usage of the computing resources comprises a recommendation system detecting the inefficiencies, and wherein providing the notification indicating the inefficiencies and the subset of the computing resources that are producing the inefficiencies comprises the recommendation system providing a recommendation to modify an allocation of the computing resources.

10. The method of claim 9, wherein the inefficiencies are detected based on a trend analysis or volume analysis of the usage of the computing resources, and wherein the recommendation to modify the allocation of the computing resources comprises a suggestion to change a type or quantity of the computing resources used.

11. The method of claim 9, wherein the inefficiencies are detected based on a carbon footprint analysis of the usage of the computing resources, and wherein the recommendation to modify the allocation of the computing resources comprises a suggestion to replace at least some of the computing resources with more power efficient computing resources.

12. The method of claim 1, wherein determining the inefficiencies related to the usage of the computing resources is caused by addition of a pre-determined number of the records to the structured data.

13. A non-transitory computer-readable medium, having stored thereon program instructions that, upon execution by one or more processors, cause the one or more processors to perform operations comprising:
receiving, from a computing system, usage data including entries specifying usage of computing resources of the computing system;
storing, as structured data, records that include representations of the entries;
after storing the records, determining, based on an efficiency criterion and for a time range of the records, inefficiencies related to the usage of the computing resources; and
providing a notification indicating the inefficiencies and a subset of the computing resources that are producing the inefficiencies.

14. The non-transitory computer-readable medium of claim 13, the operations further comprising:
modifying, by way of remote access to the computing system, future use of the subset of the computing resources so that the inefficiencies are reduced.

15. The non-transitory computer-readable medium of claim 13, wherein the structured data includes a distributed, cryptographically immutable sequence of blocks containing the records.

16. The non-transitory computer-readable medium of claim 13, wherein the structured data includes a time series database containing the records.

17. The non-transitory computer-readable medium of claim 13, wherein determining the inefficiencies related to the usage of the computing resources comprises an alerting system detecting abnormal patterns of the usage in the time range of the records, and wherein providing the notification indicating the inefficiencies and the subset of the computing resources that are producing the inefficiencies comprises the alerting system providing an alert relating to the abnormal patterns of the usage.

18. The non-transitory computer-readable medium of claim 13, wherein determining the inefficiencies related to the usage of the computing resources comprises a recommendation system detecting the inefficiencies, and wherein providing the notification indicating the inefficiencies and the subset of the computing resources that are producing the inefficiencies comprises the recommendation system providing a recommendation to modify an allocation of the computing resources.

19. The non-transitory computer-readable medium of claim 13, wherein determining the inefficiencies related to the usage of the computing resources is caused by addition of a pre-determined number of the records to the structured data.

20. A system comprising:
one or more processors; and
memory, containing program instructions that, upon execution by the one or more processors, cause the system to perform operations comprising:
receiving, from a computing system, usage data including entries specifying usage of computing resources of the computing system;
storing, as structured data, records that include representations of the entries;
after storing the records, determining, based on an efficiency criterion and for a time range of the records, inefficiencies related to the usage of the computing resources; and
providing a notification indicating the inefficiencies and a subset of the computing resources that are producing the inefficiencies.
